(19) United States
(12) Patent Application Publication
(10) Pub. No.: US 2012/0110743 A1
(43) Pub. Date: May 10, 2012

(54) FLUIDIZABLE MEDIUM SUPPORT BED

(75) Inventor: Ching-Fong LIU, Taipei (TW)

(73) Assignee: CAREMED SUPPLY, INC., Taipei (TW)

(21) Appl. No.: 12/939,190

(22) Filed: Nov. 4, 2010

(51) Int. Cl. A61G 7/057

(52) U.S. Cl. 5/689

(57) ABSTRACT

A fluidizable medium support bed includes a bed body, a blower, a support board, a diffuser board and a metal frame. The bed body includes a support cavity for supporting a fluidizable medium. The bed body includes an expanded polystyrene (EPS) body and a coating covering all outer surfaces of the EPS body. The blower is connected to a bottom surface of the support cavity to provide an airflow. The support board has a plurality of ventholes and is disposed on the bottom surface of the support cavity. The diffuser board is disposed over the support board, wherein the diffuser board is permeable to air but impermeable to the fluidizable medium. The metal frame is disposed over a circumference of the support cavity.

### BACKGROUND

1. Field of Invention

The present invention relates to a bed. More particularly, the present invention relates to a bed that provides airflows to circulate a fluidizable medium for supporting a human body.

2. Description of Related Art

Fluidizable medium support beds have been used as patient support systems. In this type of bed, a fluidizable medium such as tiny spheres formed of glass, ceramics, or silicone is contained within a suitable support and fluidized by air passing through the support mechanism to support the patient. In a common design, the fluidizable medium is supported by a diffuser board which is permeable to air but impermeable to the fluidizable medium.

Fluidizable medium support beds provide an excellent support surface for patients to help prevent formation of bed sores because of the equal distribution of pressure on the support surface. In addition, fluidized beds are well suited for treatment of patients with skin grafts because the fluidized support surface does not produce high shear, frictional forces when the patient moves on the bed.

Conventional fluidizable medium support beds are made from almost metal materials (e.g. the bed body as disclosed in U.S. Pat. No. 6,073,289) in order to support hundred of kilograms of the fluidizable mediums. Therefore, the whole bed body (not including the fluidizable medium) is very heavy for a common household to easily move in his or her house. Besides, the metal made bed body is also expensive, thereby causing the fluidizable medium support bed's price too high and inhibiting the market of the fluidizable medium support bed.

### SUMMARY

It is therefore an objective of the present invention to provide a light-weight fluidizable medium support bed.

In accordance with the foregoing and other objectives of the present invention, a fluidizable medium support bed includes a bed body, a blower, a support board, a diffuser board and a metal frame. The bed body includes a support cavity for supporting a fluidizable medium. The bed body includes an expanded polystyrene (EPS) body and a coating covering all outer surfaces of the EPS body. The blower is connected to a bottom surface of the support cavity to provide an airflow. The support board has a plurality of ventholes and is disposed on the bottom surface of the support cavity. The diffuser board is disposed over the support board, wherein the diffuser board is permeable to air but impermeable to the fluidizable medium. The metal frame is disposed over a circumference of the support cavity.

According to an embodiment disclosed herein, the fluidizable medium support bed includes a spacer disposed under the bed body to raise the bed body.

According to another embodiment disclosed herein, the coating is a paint that does not corrode the EPS body.

According to another embodiment disclosed herein, the coating has a thickness ranging from about 3 mm to about 6 mm.

According to another embodiment disclosed herein, the coating is a waterproof, anti-wear paint that does not corrode the EPS body.

According to another embodiment disclosed herein, the EPS body has a density ranging from about 16 to about 18 kilograms/m³.

According to another embodiment disclosed herein, the support board is a metal mesh or a metal plate full of vents.

According to another embodiment disclosed herein, the metal frame is made from aluminum, magnesium, titanium, stainless steel or alloys thereof.

According to another embodiment disclosed herein, the bed body includes an accommodation cavity to house the blower.

According to another embodiment disclosed herein, the support cavity includes a vent cavity on the bottom surface thereof and the vent cavity extends along a long axis of the bed body.

Thus, the fluidizable medium support bed's bed body is made from an EPS body plus a coating to reduce its weight effectively and maintain its strength and rigidity for supporting the heavy fluidizable medium. Besides, the metal frames are attached over the thinner sidewall around the support cavity to enhance its strength and rigidity.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a perspective view of a fluidizable medium support bed according to one embodiment of this invention;

FIG. 2 illustrates a top view of the fluidizable medium support bed in FIG. 1;

FIG. 3 illustrates an exploded view of the fluidizable medium support bed in FIG. 1;

FIG. 4 illustrates a top view of the bed body in FIG. 3;

FIG. 5 illustrates a side view of the bed body in FIG. 3; and

FIG. 6 illustrates a cross-sectional view taken along the line 6-6′ in FIG. 5.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

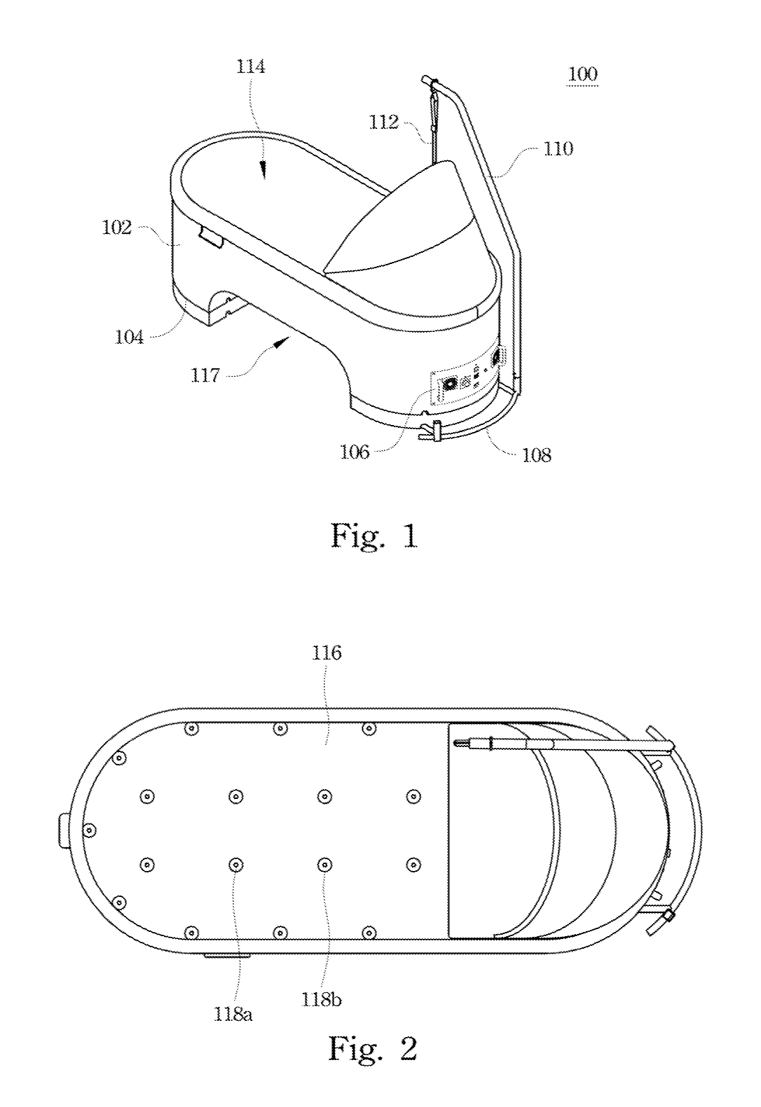

Referring to FIG. 1, which illustrates a perspective view of a fluidizable medium support bed according to one embodiment of this invention. A fluidizable medium support bed 100 basically includes a bed body 102 and a blower 106. The bed body 102 includes a support cavity 114 for accommodating a fluidizable medium, e.g. sands, glass, ceramic or silicone particles, that can be easily circulated by an airflow. The blower 106 is connected to a bottom surface of the support cavity 114 of the bed body 102 for providing an airflow to circulate the fluidizable medium.

The fluidizable medium support bed 100 may include a spacer 104 located under the bed body 102 to raise the bed body 102 to a higher position, but the spacer 104 is not an essential component of the fluidizable medium support bed 100.

The fluidizable medium support bed 100 may further include a group of components (e.g. a bottom frame 108, a suspension arm 110, a suspension rope 112 and a triangular frame 112a) to suspend arms and legs of a patient.

The bed body 102 has an optional arc-shaped cutout 117 for other medical equipments to insert, e.g. a medical lifter's foot may be inserted under the arc-shaped cutout 117 such that it is capable of lifting a patient or his legs or arms on the bed. If this function is not needed, the arc-shaped cutout 117 may be removed.

Referring to FIG. 2, which illustrates a top view of the fluidizable medium support bed in FIG. 1. This view shows the bed body 102 with its support cavity 114 not yet filled with the fluidizable medium. A diffuser board 116 is installed over a bottom surface of the support cavity 114. The diffuser board 116 is permeable to airflow but impermeable to the fluidizable medium. That is, when the support cavity 114 is filled with the fluidizable medium, the fluidizable medium cannot penetrate through the diffuser board 116, but the airflow can penetrate through the diffuser board 116 to circulate the fluidizable medium. Bolts 118a and washers 118b are used to secure the diffuser board 116 to the bottom surface of the support cavity 114 (each bolt 118a is inserted through respective washer 118b and screwed into a corresponding screw hole on the bottom surface of the support cavity 114).

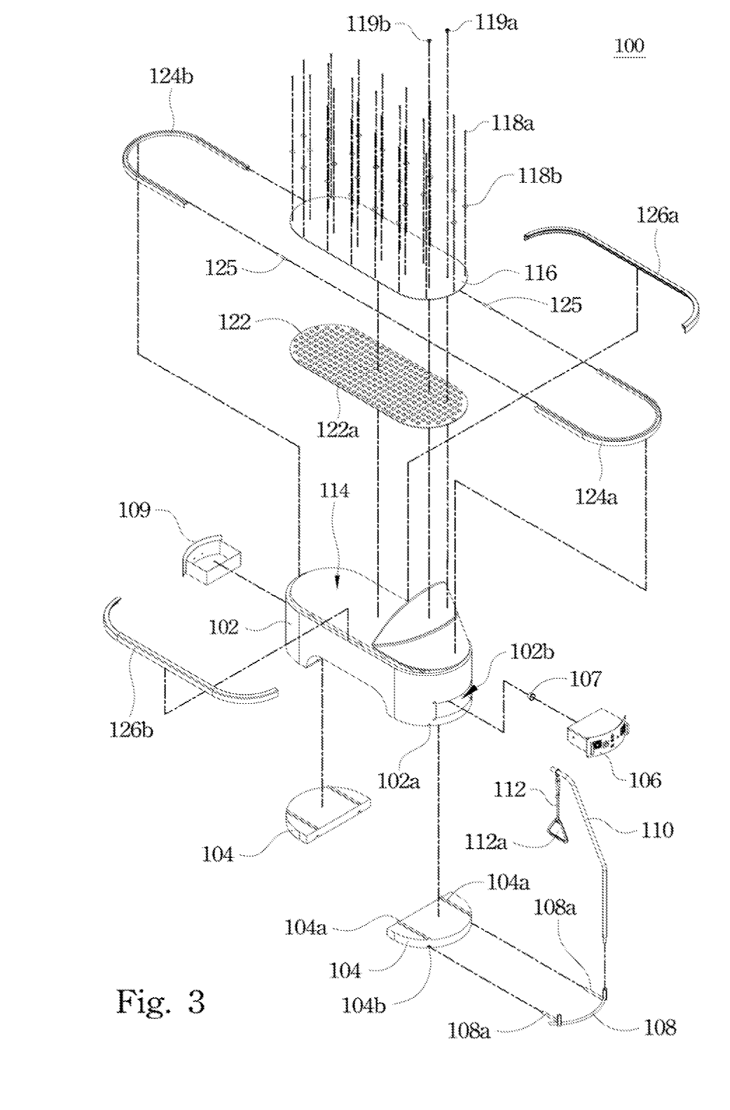

Referring to FIG. 3, which illustrates an exploded view of the fluidizable medium support bed in FIG. 1. In this embodiment, the bed body 102 is made from expanded polystyrene (hereafter EPS). In order to increase the rigidity and strength of the bed body 102, two metal frames (124a, 124b) are attached to a circumference of the support cavity 114. Therefore, the sidewalls of the support cavity 114 can be strengthened. The two U-shaped metal frames (124a, 124b) can be connected by a pair of connection members 125 to fully cover a circumference of the support cavity 114. Additional two plastic frames (126a, 126b) can be attached over the two metal frames (124a, 124b) to house and secure the two metal frames (124a, 124b). The two plastic frames (126a, 126b) can be connected with each other to fully cover the circumference of the support cavity 114.

The support cavity 114 of the bed body 102 basically needs a diffuser board 116 and a support board 122 to perform it basic function, i.e. supporting and circulating the fluidizable medium. The diffuser board 116 is permeable to airflow but impermeable to the fluidizable medium. The diffuser board 116 can be air-impermeable flat board, which is made from paper or cloth, to impede the fluidizable medium from penetrating through the diffuser board 116, but the airflow can penetrate through the diffuser board 116 and circulate the fluidizable medium. The support board 122 is lined under the diffuser board 116 to reinforce the diffuser board 116 to support the fluidizable medium's weight (e.g. hundreds of kilograms). The support board 122 is also permeable to airflow and has a stronger rigidity than the diffuser board 116 has. The support board 122 can be a metal mesh or a metal plate full of vents or ventholes. As illustrated in FIG. 3, ventholes 122a are uniformly arranged on the support board 122 such that airflows can be evenly transferred through the support board 122. The diffuser board 116 also has holes, which is only for bolts 118a to led through, not a venthole. Each bolt 118a is inserted through a respective washer 118b, a corresponding hole of the diffuser board 116 and a corresponding venthole 122a of the support board 122, and then screwed into a corresponding hole on the bottom surface of the support cavity 114. The washer 118b is to evenly distribute the pressures the blot 118a applies and prevent the fluidizable medium from penetrating through the holes of the diffuser board 116. The above-mentioned way to secure the diffuser board 116 to the bottom of the support cavity 114 is just an example, not the only way to secure the diffuser board 116. Persons skilled in the art can use other proper ways to secure the diffuser board 116 according to respective demands.

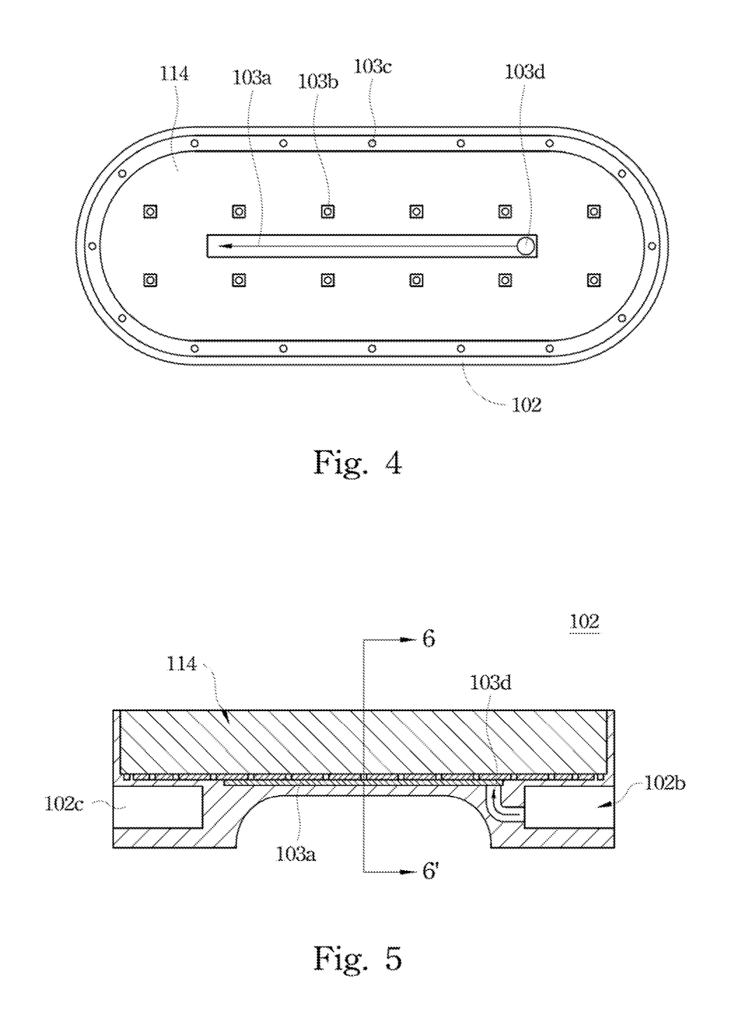

The bed body 102 may have an accommodation cavity 102b on its outer wall to install the blower 106 within. The blower 106 is connected to an air channel 103d of the bed body 102 by a connection hose 107 (referring to both FIG. 4 and FIG. 5). The bed body 102 may include a drawer 109 located opposite to the blower 106 and installed within an accommodation cavity 102c.

The fluidizable medium support bed 100 may include a spacer 104 to lift the bed body 102 to a higher position. The spacer 104 has a strip convex member 104a on its top surface while the bed body 102 has a strip concave slot 102a on its bottom surface. When the strip convex member 104a engages the strip concave slot 102a, the bed body 102 can be reliably positioned on the spacer 104.

The fluidizable medium support bed 100 may further include a group of components (e.g. a bottom frame 108, a suspension arm 110, a suspension rope 112 and a triangular frame 112a) to suspend arms and legs of a patient. By inserting a fastener 108a of the bottom frame 108 into a bottom insert hole 104b of the spacer 104, the bottom frame 108 can be secured to the bed body 102. The suspension arm 110 is installed upright on the bottom frame 108, and equipped with a suspension rope 112 and a triangular frame 112a for fastening an arm or a leg of a patient thereon.

Besides, the fluidizable medium support bed may have a temperature control function. A heater can be installed within the blower 106 or at an air channel along which the blower 106 outputs its airflow. A temperature sensor 119a and a temperature switch 119b can be collectively used to control the temperature of the fluidizable medium support bed. The temperature sensor 119a can be attached to the diffuser board 116, the support board 122 or other desired positions to sense environmental temperature. The temperature switch 119b is to turn on or turn off the heater. When the temperature sensor 119a senses that a target temperature has been achieved, the temperature switch 119b turns off the heater.

Referring to FIG. 4 and FIG. 5, wherein FIG. 4 illustrates a top view of the bed body in FIG. 3 (the diffuser board 116 and support board 122 are removed) and FIG. 5 illustrates a side view of the bed body in FIG. 3. As discussed above, the bed body 102 is an EPS body such that the bolt cannot be screwed within the EPS materials. Therefore, several nuts (103b, 103c) are buried on the bottom surface of the support cavity 114 for the bolts 118a to be screwed into a skew hole of the nuts (103b, 103c). Two rows of nuts 103b are arranged in parallel with the vent cavity 103a. The nuts 103c are arranged along a circumference of the bottom surface of the support cavity 114. The vent cavity 103a extends along a long axis of the bed body 102, thereby distributing the airflow rapidly along the arrow as illustrated in FIG. 4. After the blower 106 is installed within the accommodation cavity 102b (referring to FIG. 5), the blower 106 outputs the airflow to air channel 103d along the arrow and the airflow is guided to the vent cavity 103a.

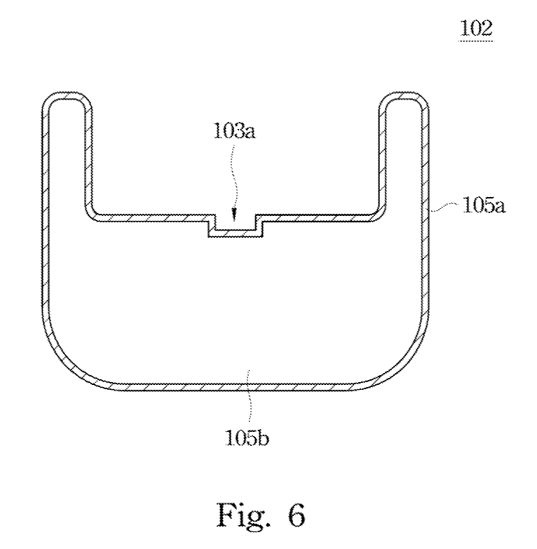

Referring to FIG. 6, which illustrates a cross-sectional view taken along the line 6-6′ in FIG. 5. In this embodiment, the bed body 102 basically includes the EPS body 105b and a coating 105a. The coating 105a covers all outer surfaces of the EPS body 105b so as to strengthen the bed body and enhances waterproof and anti-wear characteristics. In this embodiment, the EPS body 105b has a density ranging from about 16 to about 18 kilograms/m³. Higher density contributes the bed body's rigidity, but also increases bed body's weight. The above-mentioned density range is a better density, which balances the bed body's rigidity and weight. Besides, the coating 105a is another factor to increase the bed body's rigidity. In this embodiment, the coating 105a has a thickness ranging from about 3 mm to about 6 mm. When the thickness of the coating 105a is less than about 3 mm, the bed body's rigidity is not enhanced effectively. When the thickness of the coating 105a is greater than about 6 mm, the bed body's weight is increased too much. The coating 105a should be at least a paint that does not corrode the EPS body, preferably be a waterproof, anti-wear paint that does not corrode the EPS body.

Besides, the bed body 102 has a thinner sidewall around the support cavity 114 (compared with a bottom wall of the support cavity 114) such that the metal frames (124a, 124b) are attached to strengthen the sidewall. The metal frames (124a, 124b) can be made from aluminum, magnesium, titanium, stainless steel or alloys thereof.

According to the discussed embodiments, the fluidizable medium support bed's bed body is made from an EPS body plus a coating to reduce its weight effectively and maintain its strength and rigidity for supporting the heavy fluidizable medium. Besides, the metal frames are attached over the thinner sidewall around the support cavity to enhance its strength and rigidity.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A fluidizable medium support bed comprising:
a bed body comprising a support cavity for supporting a fluidizable medium, wherein the bed body comprises:
an expanded polystyrene (EPS) body; and
a coating covering all outer surfaces of the EPS body;
a blower connected to a bottom surface of the support cavity to provide an airflow;
a support board having a plurality of ventholes and being disposed on the bottom surface of the support cavity;
a diffuser board being disposed over the support board, wherein the diffuser board is permeable to air but impermeable to the fluidizable medium; and
a metal frame being disposed over a circumference of the support cavity.

2. The fluidizable medium support bed of claim 1 further comprising a spacer disposed under the bed body to raise the bed body.

3. The fluidizable medium support bed of claim 1, wherein the coating is a paint that does not corrode the EPS body.

4. The fluidizable medium support bed of claim 1, wherein the coating has a thickness ranging from about 3 mm to about 6 mm.

5. The fluidizable medium support bed of claim 1, wherein the coating is a waterproof, anti-wear paint that does not corrode the EPS body.

6. The fluidizable medium support bed of claim 1, wherein the EPS body has a density ranging from about 16 to about 18 kilograms/m³.

7. The fluidizable medium support bed of claim 1, wherein the support board is a metal mesh or a metal plate full of vents.

8. The fluidizable medium support bed of claim 1, wherein the metal frame comprises aluminum, magnesium, titanium, stainless steel or alloys thereof.

9. The fluidizable medium support bed of claim 1, wherein the bed body comprises an accommodation cavity to house the blower.

10. The fluidizable medium support bed of claim 1, wherein the support cavity comprises a vent cavity on the bottom surface thereof and the vent cavity extends along a long axis of the bed body.
